(19) United States
(12) Patent Application Publication
(10) Pub. No.: US 2007/0170013 A1
(43) Pub. Date: Jul. 26, 2007

(54) Elevator rail support bracket

(76) Inventor: Jim A. Rivera, Bristol, CT (US)

Correspondence Address: John M Siragusa;Carlson, Gaskey & Olds, 400 W Maple Road, Suite 350, Birmingham, MI, 48009, US

(21) Appl. No.: 10/588,388

(22) PCT Filed: Feb. 19, 2004
(86) PCT No.: PCT/US04/04952

§ 371 Date: Aug. 4, 2006

(51) Int. Cl. B66B 7/02

(52) U.S. Cl. 187/408

(57) ABSTRACT

A mounting bracket for a guide rail (12) includes first and second clips (20A, 20B) secured to a mount (18). The first and second clips (20A,20B) establish a clamping dimension (32) when they are received about a flange (38) of the guide rail (12). The mount (18) secures to a hoistway wall (14). A bolt (22) and nut (24) adjustably secure the clips (20A,20B) in a spaced relationship to each other around the flange (38). Adjustment of the clamping distance (32) provides for mounting various sized guide rails (12) with a common sized mounting bracket (10). The clips are also selectively moveable relative to the mount to facilitate plumbing the guide rail (12) within the hoistway (14).

### FIELD OF THE INVENTION

This invention generally relates to a mounting assembly for mounting an elevator or counter weight guide rail within a hoistway.

### DESCRIPTION OF THE RELATED ART

Typically, an elevator system includes guide rails mounted within a hoistway for guiding an elevator car and counterweight during movement between floors of a building. The guide rails are secured to the hoistway walls or structural beams by mounting brackets. The mounting brackets are spaced apart from each other at defined intervals along the guide rail to support the guide rail and provided a sufficiently rigid mounting.

The guide rail is typically a T-shaped beam having a flange portion secured to the mounting brackets, which are secured to the wall or structural beams. The mounting brackets typically comprise Z-shaped rail clips overlapping that portion of the guide rail fastened to the wall or another structural beam within the hoistway. The mounting brackets and the two rail clips secure, trap and clamp the flange portion of the guide rail against an inner wall or structural beam within the hoistway.

During installation, the guide rail must be moved into a proper mounting position before the brackets can be fixed to secure the guide rail in place. The brackets often turn with movement of the guide rail causing an undesirable twisting and locking of the clips against the guide rail. In addition, typically, different size brackets are required for each different size guide rail. Further, movement of the guide rail for alignment and to compensate for inconsistencies in the guide rail are not easily accommodated with conventional Z-shaped rail clips.

Accordingly, it is desirable to develop and design a mounting bracket that is adjustable to accommodate different size guide rails, and that can be movably secured to the guide rail to aid in installation within a hoistway.

### SUMMARY OF INVENTION

The present invention is a mounting bracket assembly for securing a guide rail within a hoistway including two identically shaped clips of opposite hands secured to a mount.

Each mounting bracket clamps onto a flange portion of the guide rail to hold the guide rail in a desired, aligned position. The mounting bracket includes first and second clips secured to a mount. The mount secured to the hoistway wall or other structure within the hoistway. The first and second clips are secured in a spaced relationship to establish a clamping dimension within which the guide rail flange is clamped. The clamping dimension adjusts to correspond to a width of the flange. The mounting brackets trap the guide rail in the post direction, while still allowing vertical movement. The adjustable clamping dimension provides for mounting various sizes of guide rails using a single size of mounting bracket.

Accordingly, this invention provides an adjustable mounting bracket that is capable of accommodating a plurality of guide rail sizes and is movably securable to the guide rail to aid in installation within the hoistway.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of an elevator system;

FIG. 2 is a schematic view of a guide rail mounted within a hoistway with an example mounting bracket designed according to this invention;

FIG. 3 is a perspective view of the example mounting bracket of FIG. 2 attached to the guide rail;

FIG. 4, is top view of the example mounting bracket attached to the guide rail; and

FIG. 5 is an exploded view of the example mounting bracket.

### DETAILED DESCRIPTION OF THE PREFERRED EMBODIMENT

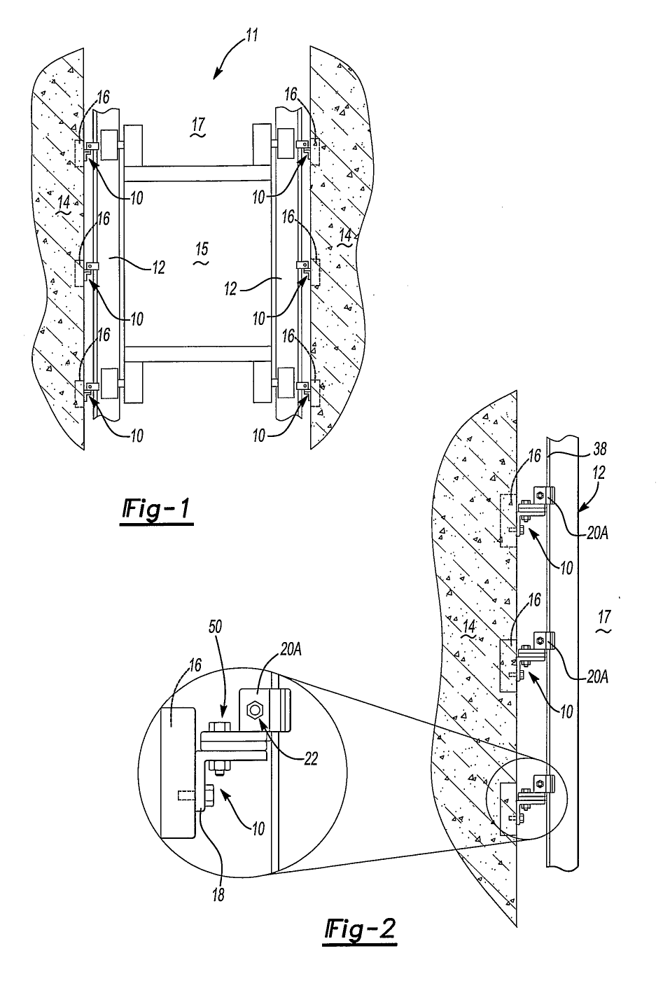

Referring to FIG. 1, an elevator system 11 is schematically shown and includes an elevator car 15 movable within a hoistway 17 along guide rails 12. The guide rails 12 are secured to structures 16 within the walls 14 of the hoistway 17 by mounting bracket assemblies 10.

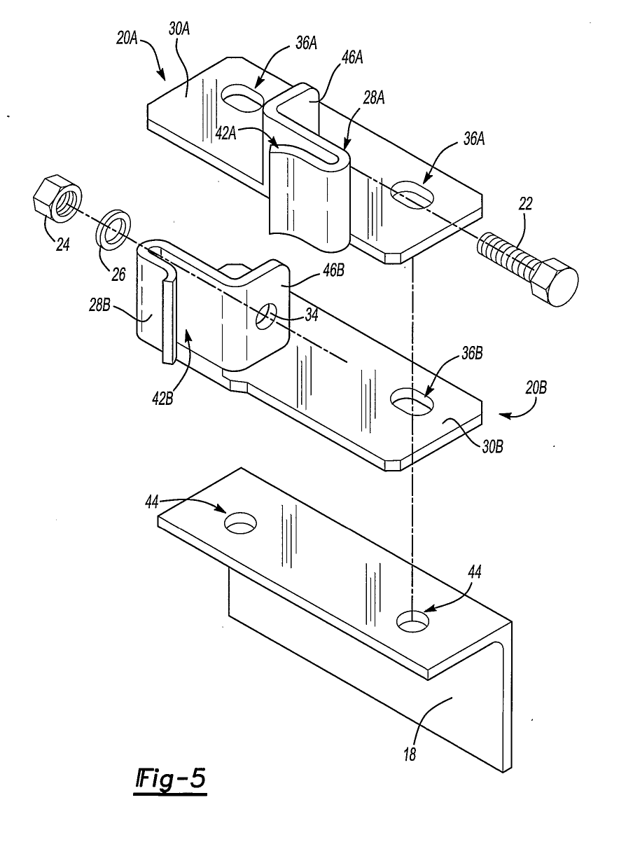

Referring to FIGS. 2-5, a portion of the hoistway 17 is shown and includes the hoistway wall 14 and several of the structures 16, which comprise conventional beams in one example. The mounting brackets assemblies 10 clamp onto a flange portion 38 of the guide rail 12 to hold the guide rail 12 in a desired, aligned position. Each mounting bracket assembly 10 includes first and second clips 20A, 20B secured to a mount 18 by at least one fastener 50. The mount 18 attaches to the structure 16 within the hoistway wall 14. The mount 18 can be attached to any fixed structure within the hoistway 17 to fix the guide rail 12 in an aligned position.

The first and second clips 20A, 20B are secured in relation to each other to clamp the flange portion 38 of the guide rail 12 between the clips. A bolt 22 and nut 24 secures the clips 20A, 20B to one another and in clamping engagement with the flange 38 in this example. The fastener 50 secures the first and second clips 20A, 20B to the mount 18. The clips 20A, 20B are preferably mirror images of each other such that only one configuration of each clip 20A, 20B is necessary for each side of the mounting bracket assembly 10.

Referring to FIG. 4, a clamping dimension 32 between the first and second clips 20A, 20B is adjustable by selectively tightening the bolt 22 and nut 24 that hold the first and second clips 20A, 20B in spaced relation to one another. The clamping dimension 32 corresponds to a width of the flange 38 of the guide rail 12. Adjusting the clamping dimension 32 accommodates various sized guide rails 12 with a single size and configuration of the clips or the entire mounting bracket assembly 10. Further, the variable clamping dimension 32 facilitates moving of the clips relative to the guide rail 12 that in turn facilitates easier installation, adjustment and alignment of the guide rail 12 within the hoistway 17.

Each clip 20A, 20B includes a first segment 28A, 28B for clamping attachment about the flange 38 of the guide rail 12. The first segments 28A, 28B of each clip 20A, 20B includes a generally c-shaped clamp portion 42A, 42B. Open ends 48A, 48B of each clamp portion 42A, 42B face each other when the cups are received at least partially on the flange 38. The distance between the clamp portions 42A, 42B establishes the clamping dimension 32.

In the illustrated example, the clamp portions 42A, 42B transition into a link portion 46A, 46B. Each link portion 46A, 46B consists of a rectangular planar member having facing surfaces. The link portions 46A, 46B each include an opening 34 for receiving the bolt 22.

The first segments 28A, 28B provide the securing features for attachment to the flange 38. A second segment 30A, 30B facilitates securing adjustably the clips 20A, 20B to a corresponding mount 18. The second segments 30A, 30B are generally rectangular plates that rest one atop the other.

The second segments 30A, 30B include openings 36A, 36B that align with each other and with openings 44 within the mount 18. A fastener 50 extends at least partially into each of the openings 36A, 36B and 44 to secure the first and second clips 20A, 20B to the mount 18. Preferably the openings 36A, 36B are slots larger than an outside dimension (i.e., width) of the fasteners 50 to accommodate lateral adjustment of the clips 20A, 20B relative to the mount 18. Although slots are shown, the openings 36A, 36B may be any shape that allows adjustment of the spaced relationship between the first and second clips 20A, 20B and thereby the clamping dimension 32.

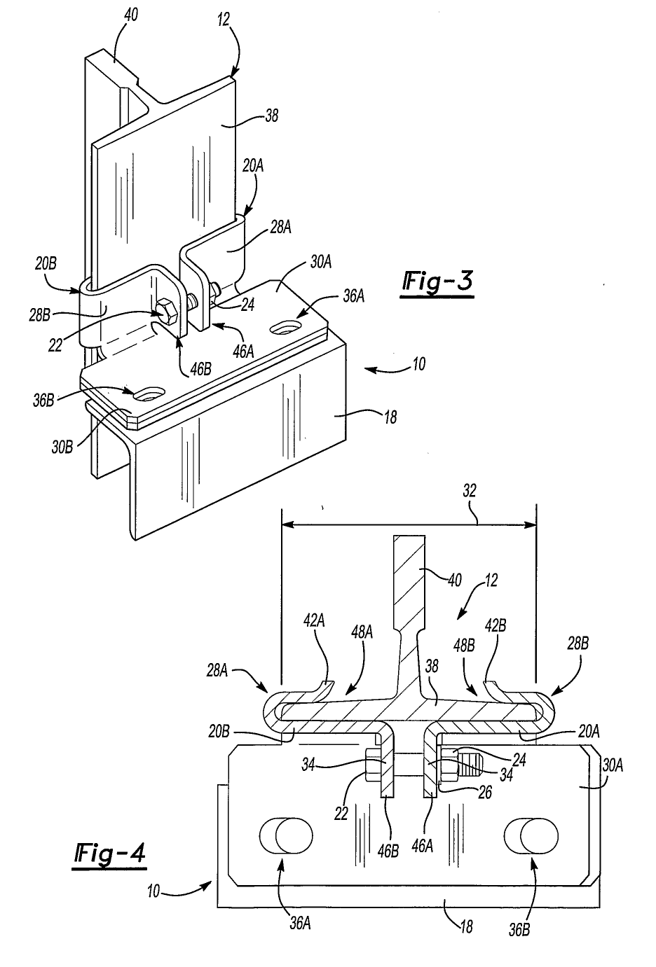

Referring back to FIG. 3, the adjustable configuration of the clips 20A, 20B provides for selective sliding movement of the mounting bracket assembly 10 (or at least the clips) longitudinally along the guide rail 12 during installation within the hoistway 17. The clips are loosely attached to the flange 38 of a corresponding guide rail 12 and moved into a desired mounting position corresponding to where a corresponding the mount 18 is secured (or to be secured) within the hoistway 17.

The mounting brackets 10 are movably secured by selectively adjusting the bolt 22 and nut 24 such that the clamping dimension 32 is larger than the flange 38 to allow longitudinal sliding. Once the mount 18 is secured, and no further longitudinal movement of the mounting bracket assembly 10 relative to the guide rail 12 is required, the bolt 22 and nut 24 are tightened to clamp the clips 20A, 20B tightly about the flange 38 such that no relative movement occurs between the clips 20A, 20B and the flange 38.

Lateral movement of the guide rail 12 to plumb the rail, for example, is still possible with the clips 20A, 20B tightly secured to the flange 38 by way of the elongated openings 36A, 36B. With the fasteners 50 adjusted accordingly, both clips 20A, 20B and the rail 12 can move sideways relative to the mount 18. Once final adjustment is made to place the guide rail 12 in the desired alignment, the fasteners 50 are tightened to secure the portions of the bracket assemblies together and to secure guide rail 12 in place. Subsequent adjustments and corrections to the desired alignment of the guide rail 12 can be accomplished by loosening appropriate fasteners 50 in order to allow additional movement of the guide rail 12.

It should be noted that a variety of orders of assembly steps may be used. For example, all of the mounts 18 maybe be positioned and secured in the hoistway before the clips are received on the flange 38. The fasteners 50 and 22 may be repeatedly adjusted as needed during an installation or maintenance procedure.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1-21. (canceled)

22. A mounting bracket assembly (10) for an elevator system guide rail (12) comprising:
a mount (18) securable within a hoistway; and
first and second clips (20A,20B) securable to each other for establishing a selectively adjustable clamp dimension (32) for securing the guide rail (12), each of said first and second clips (20A,20B) securable to said mount (18).

23. The assembly (10) as recited in claim 22, wherein each clip (20A,20B) comprises a first segment (28) securable to the guide rail (12) and a second segment (30) securable to said mount (18).

24. The assembly (10) as recited in claim 23, wherein said first segments (28) each comprise a C-shaped portion, a spacing between said C-shaped portions establishes the clamp dimension (32).

25. The assembly (10) as recited in claim 24, wherein said clamp dimension (32) is selectively adjustable to accommodate the guide rail (12).

26. The assembly (10) as recited in claim 23, comprising at least one opening (34) in each said first segment (28) and including a fastening member received at least partially into the openings (34) to secure said first and second clips (20A,20B) in a fixed position relative to each other.

27. The assembly (10) as recited in claim 23, wherein each said second segment (30) includes at least one opening (36) and including a securing member (50) at least partially received through said opening (36) to secure said clips (20A,20B) to said mount (18).

28. The assembly (10) as recited in claim 27, wherein said opening (36) has at least one dimension that is larger than a portion of said securing member (50) received within said opening (36) to allow selected movement of said clips (20A,20B) relative to said mount (18).

29. The assembly (10) as recited in claim 22, wherein said first and second clips (20A,20B) are mirror images of one another.

30. The assembly (10) as recited in claim 22, wherein said first and second clips (20A, 20B) remain substantially perpendicular during vertical movement of the guide rail (12).

31. An elevator system (11) comprising:
an elevator car (15);
at least one guide rail (12) for guiding movement of the car; and
a mounting bracket assembly (10) for securing said guide rail within a hoistway, said mounting bracket assembly comprising a mount (18) securable in a fixed position, and first and second clips (20A,20B) adjustably secured to each other and to the mount for establishing a selectively adjustable clamping dimension (32) for securing the guide rail (12) to the mounting bracket assembly.

32. The system (10) as recited in claim 31, wherein each clip (20A,20B) comprises a first segment (28) securable to the guide rail (12) and a second segment (30) securable to said mount (18) and including open portion facing each other establishing a clamp dimension (32) therebetween.

33. The assembly (10) as recited in claim 32, wherein said clamp dimension (32) is adjustable to accommodate the guide rail (12).

34. The assembly (10) as recited in claim 32, comprising an opening (34) in said first segments (28) and a fastening member received at least partially through the openings to clamp said first and second clips (20A,20B) about the guide rail (12).

35. The assembly (10) as recited in claim 32, wherein each of said second segments (30) include at least one opening (36) and a securing member at least partially received through said opening to secure said clips (20A,20B) to said mount (18).

36. The assembly (10) as recited in claim 35, wherein said opening is larger than a portion of said securing member received within said opening to allow selected movement of said clips (20A,20B) relative to said mount.

37. A method of installing a guide rail (12) within a hoistway comprising the steps of:
a) positioning a first clip (20A) and a second clip (20B) about a guide rail (12) by securing the first clip (20A) to the second clip (20B);
b) moving said first and second clips (20A,20B) to a mounting position;
c) securing said first and second clips (20A,20B) to a mount (18); and
d) securing said mount (18) in a fixed position.

38. The method as recited in claim 37, comprising aligning the guide rail (12) within the hoistway after the clips are in the mounting position.

39. The method as recited in claim 38, comprising sliding the first and second clip (20A,20B) longitudinally along the guide rail (12) to the mounting position.

40. The method as recited in claim 37, comprising adjusting a clamp dimension (32) between said first and second clips (20A,20B).

41. The method as recited in claim 37, comprising laterally adjusting said first and second clips (20A,20B) relative to said mount (18) to allow lateral positioning of the guide rail (12).

42. The method as recited in claim 41, comprising aligning said guide rail (12) by moving said first and second clips (20A,20B) relative to said mount (18).
